(19) United States
(12) Patent Application Publication
(10) Pub. No.: US 2008/0198015 A1
(43) Pub. Date: Aug. 21, 2008

(54) RFID SYSTEM

(76) Inventors: Daniel Lawrence, Ann Arbor, MI (US); Richard Fletcher, Somerville, MA (US); Richard Redemske, Belmont, MA (US)

Correspondence Address: HOLLAND & KNIGHT LLP, 10 ST. JAMES AVENUE, 11th Floor, BOSTON, MA, 02116-3889, US

(21) Appl. No.: 11/676,711

(22) Filed: Feb. 20, 2007

(51) Int. Cl. G08B 25/10

(52) U.S. Cl. 340/572.4

(57) ABSTRACT

An RFID system including a battery powered RFID reader configured to detect an RFID tag. The RFID reader include a mounting surface configured to be affixed relative to an external structure, and is capable of being wirelessly coupled to a receiver for transmitting data to the receiver.

### TECHNICAL FIELD

The present disclosure relates to radio frequency identification (RFID) systems and, more particularly, to wirelessly coupled RFID readers.

### BACKGROUND

RFID systems are used in connection with a variety of applications, ranging from inventory control, theft prevention, security access, and mass transit, etc. In retail applications, for example, RFID tags may contain security and/or verification information and are typically attached to an article for purchase. The RFID tags may store information regarding the article, for example the source or authenticity of the article, and may be used in inventory control systems. RFID verification devices, i.e., RFID readers, which are generally located inside a store or a warehouse, may read the RFID tag, and determine the location of an article and/or information regarding the article.

Two common varieties of RFID readers include stationary RFID readers and handheld RFID readers. Stationary RFID readers are typically used for monitoring or detecting RFID tags relative to a specific location. For example, a stationary RFID reader may be used at a point of sale terminal to identify items being purchased, their associated prices, etc. Stationary RFID readers are generally intended for service in one area or region for a prolonged period of time. Stationary RFID readers are, therefore, typically integrated into an inventory, point of sale, etc., system using hardwired infrastructure for electrical service and communication with other devices.

By contrast to the stationary variety, handheld RFID readers may be used for roving inventory, etc., allowing a user to monitor or detect RFID tags associated with items at a number of different locations. For example, merchandise having RFID tags may be distributed on shelves throughout a retail store. A handheld RFID reader may be used for taking inventory based on the RFID tags associated with the merchandise without the need to remove the merchandise from the shelves and transport it to a stationary RFID reader.

### SUMMARY OF THE DISCLOSURE

According to one implementation a system may be provided including an RFID reader configured to detect an RFID tag. The RFID reader may also be include a mounting surface configured to be affixed relative to an external structure. Further, the RFID reader may be capable of being wirelessly coupled to a receiver for transmitting data to the receiver.

A system consistent with the present disclosure may include one or more of the following features. The mounting surface may be configured to be affixed relative to a shelving system. Furthermore, the RFID reader may include a substantially flat load bearing surface. Additionally, the mounting surface may be configured to be fixed relative to a conveyor system.

In various embodiments, the RFID reader may include a battery power source. The battery power source may include a rechargeable battery. Furthermore, the system may also include a solar cell capable of at least partially recharging the rechargeable battery.

The RFID reader may be configured to be wirelessly coupled to a second RFID reader. In a further embodiment, the RFID reader may be configured to be wirelessly coupled to a server computer.

According to another implementation, there may be provided an RFID reader including a housing configured to be affixed relative to an external structure. The RFID reader may also include a communication module that may be capable of wirelessly communicating data to a receiver. The RFID reader may also include an RFID transceiver capable of detecting an RFID tag.

An RFID reader consistent with the present disclosure may include one or more of the following features. The housing of the RFID reader may be configured to be affixed to a shelving structure. Additionally, the housing may include a substantially flat structure configured to be affixed relative to a shelf. The housing of the RFID reader may be provided having an appearance that at least partially matches a known brand.

An RFID reader consistent with the present disclosure may include a battery power source. A solar cell may be configured for at least one of: at least partially powering at least one of the RFID transceiver and the communication module, or at least partially recharging the power source.

The RFID transceiver may include an antenna and an actuator capable of moving the antenna between at least a first and a second position. The communication module of the RFID reader may be capable of wirelessly transmitting data to a second RFID reader. In a further embodiment, the communication module may be capable of wirelessly transmitting data to a server computer. The communication module and the RFID transceiver may be formed on a common substrate.

In still another implementation, a shelving system may be provided including a least one shelf. The shelving system may also include an RFID reader associated with the at least one shelf. The RFID reader may include an RFID transceiver configured to detect an RFID tag. The RFID reader of the shelving system may also include a communication module capable of wirelessly communicating with a receiver.

A shelving system consistent with the present disclosure may also include one or more of the following features. The RFID reader of the shelving system may include a substantially flat load bearing surface. Further, the RFID reader may be configured to be affixed relative to a top of the shelf. The RFID reader may include a battery.

The RFID reader may be configured to be wirelessly coupled to another RFID reader. Further, the RFID reader may be configured to be wirelessly coupled to a server computer.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an embodiment of an RFID system including an RFID reader wirelessly coupled to one or more additional devices;

FIG. 2 is a block diagram of an embodiment of an RFID reader consistent with the present disclosure;

FIG. 3 diagrammatically depicts an implementation of the RFID reader in connection with a shelving structure;

FIG. 4 diagrammatically shows one embodiment of the RFID reader;

FIG. 5 diagrammatically depicts another implementation of the RFID reader in connection with a shelving structure;

FIG. 6 diagrammatically depicts yet another implementation of the RFID reader in connection with a shelving structure; and

FIG. 7 diagrammatically depicts an implementation of the RFID reader in connection with a conveyor system.

### DETAILED DESCRIPTION

### RFID System

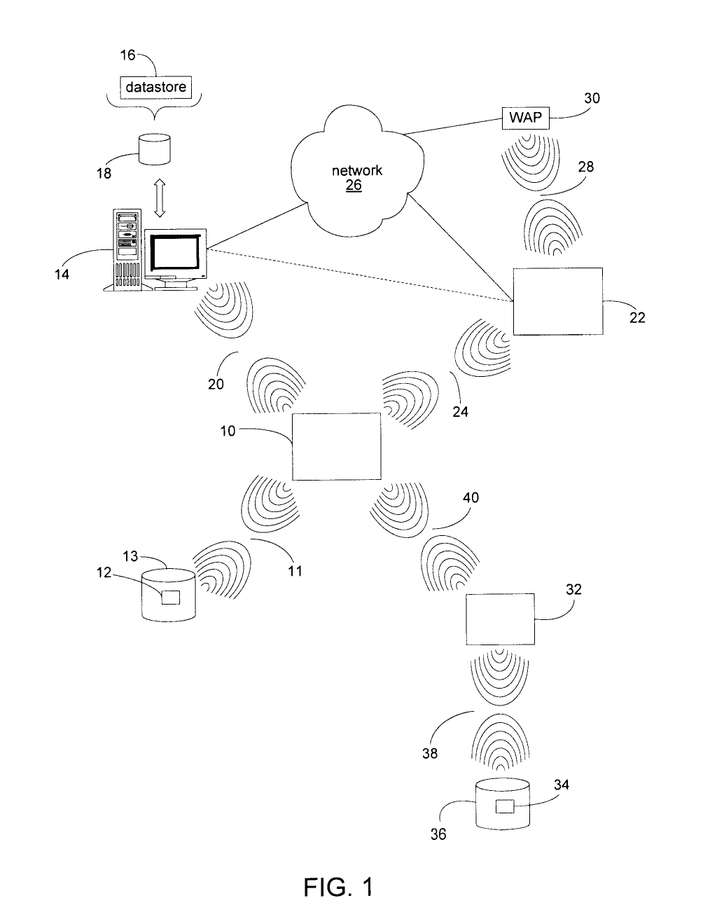

Referring to FIG. 1, there is shown an RFID system including at least one RFID reader, e.g., RFID reader 10, that may be configured to detect and/or interact with one or more RFID tags, e.g., RFID tag 12, which may be attached to an item 13. Additionally, RFID reader 10 may be wirelessly coupled to one or more additional devices for communicating with such other devices, e.g., for communicating information regarding RFID tag 12, status and/or properties of RFID reader 10, etc.

As shown, RFID reader 10 may interact with RFID tag 12, e.g., to detect the presence, identity, etc., of RFID tag 12. For example. RFID tag 12 may be a passive RFID tag, i.e., an RFID tag that does not include a power source of its own. RFID reader 10 may interrogate the passive RFID tag, e.g., by emitting a radio frequency (RF) signal, which may be received by, and/or may be incident upon, the passive RFID tag. If the passive tag is within range of RFID reader 10, the passive RFID tag may transmit an RF signal in response to the interrogation signal from RFID reader 10. The response signal from the RFID tag, which may include, for example, a tag identification number, etc., may be received by RFID reader 10.

In another example, RFID tag 12 may be an active RFID tag, i.e., an RFID tag including a power source of its own, e.g., a battery. Similar to a passive RFID tag, RFID reader 10 may interrogate an active RFID tag with an RF signal, which may be received by, and/or may be incident upon, the active RFID tag. In response to the interrogation signal, the active RFID tag may transmit a response signal. The response signal from the active RFID tag may include, for example, an identification number. In addition to an identification number, an active RFID tag may provide a variety of other information, e.g., utilizing associated sensors, diagnostic modules, etc. For example the active RFID tag may provide information relating to the status of the tag, an environmental condition, such as, ambient temperature, etc. Additionally, some active RFID tags may have a relatively longer range than a passive RFID tag.

RFID reader 10 may interact with RFID tag 12 via a first wireless communication channel 11, e.g., in a first frequency band and/or using a first wireless communication protocol. The frequency band and/or wireless communication protocol may vary depending upon the nature of RFID tag 12. If RFID tag 12 is a passive RFID tag, RFID reader 10 may transmit an interrogation signal in a first frequency band, and the passive RFID tag may transmit a response signal in the same, or in a different, frequency band. An active RFID tag may utilize a different frequency and/or wireless communication protocol than a passive RFID tag. For example, an active RFID tag may utilize a wireless communication channel complying with IEEE specification 802.15.4.

RFID reader 10 may be coupled to one or more additional devices, e.g., for communicating information regarding RFID tag 12, e.g., the tag identification number, RFID reader 10, etc. Communication with the one or more additional devices may include bidirectional communication. For example, RFID reader 10 may receive instructions, operating settings, etc., from the additional devices, as well as providing information, e.g., regarding RFID tag 12 or RFID reader 10, to the additional devices. As shown in FIG. 1, RFID reader 10 may be wirelessly coupled to a server computer 14. A datastore 16 may be maintained on server computer 14, and may include information relating to one or more RFID tags, RFID readers, products, storage information, etc. For example, datastore 16 may associate an identification number of RFID tag 12 with item 13, to which RFID tag 12 is attached. Similarly, datastore 16 may associate a location with RFID reader 10. Further, based on the identification number of RFID tag 12 and the location of RFID reader 10, which may detect RFID tag 12, information regarding the location of item 13, to which RFID tag 12 is attached, may be derived. Such information may be used, for example, for inventory control, theft prevention, stocking, etc.

Examples of datastore 16 may include, but are not limited to, an Oracle™ database, an IBM DB2™ database, a Sybase™ database, a Computer Associates™ database, and a Microsoft Access™ database. Datastore 16 may be maintained, e.g., on storage device 18 coupled to server computer 14. Storage device 18 may include, but is not limited to, a hard disk drive, a tape drive, an optical drive, a RAID array, a random access memory (RAM), or a read-only memory (ROM).

RFID reader 10 may be directly coupled to server computer 14 via a wireless communication channel 20. Wireless communication channel may be, for example, a wireless communication channel complying with IEEE 802.11a, 802.11b, 802.11g, Wi-Fi, Bluetooth, IEEE 802.15.4, or ZigBee specifications.

As is known in the art, IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is know in the art, Bluetooth is a telecommunications industry specification that allows e.g., mobile phones, computers, and personal digital assistants to be interconnected using a short-range wireless connection.

IEEE 802.15.4 specification may generally be used in connection with wireless personal area networks. As is know in the art, IEEE 802.15.4 specification may use carrier sense multiple access with collision avoidance (i.e., CSMA/CA) for path sharing. Devices implementing IEEE 802.15.4 communication channels may have the ability to form mesh networks, may provide relatively low power consumption, etc.

In addition to being coupled to server computer 14, or as an alternative to being coupled to server computer 14, RFID reader 10 may be coupled to one or more other devices, such as a hub 22, for example. Other devices to which RFID reader 10 may be coupled include, but are not limited to, other RFID readers, wireless access points, etc.

RFID reader 10 may be coupled to hub 22 via a wireless communication channel 24. Wireless communication channel 24 may include, but is not limited to, a communication channel complying with IEEE 802.11a, 802.11b, 802.11g, Wi-Fi, Bluetooth, IEEE 802.15.4, or ZigBee specifications. Communication channel 24 may be the same as, or different from, communication channel 20, via which RFID reader 10 may be coupled to sever computer 14.

Hub 22 may be an intermediate device, that may itself, be coupled to one or more additional devices, such as server computer 14, one or more additional RFID readers, etc. Hub 22 may be coupled to server computer 14 directly, as shown with phantom link line, and/or through network 26 (e.g., the Internet, a local area network, a wide area network, etc.). As shown, hub 22 may be coupled to server computer 14 via a wireless communication channel 28, e.g., via wireless access point (WAP) 30, which may be coupled directly to network 26. Wireless communication channel 28 may be, for example, a communication channel complying with IEEE 802.11a, 802.11b, 802.11g, Wi-Fi, Bluetooth, IEEE 802.15.4, or ZigBee specifications. Wireless communication channel 28 may be the same as, or different from, one or more of wireless communication channel 20 and wireless communication channel 24. In another example, hub 22 may be directly coupled to server 14 via a wireless communication channel (not shown).

Continuing with the above-stated example, the RFID system may include additional RFID readers, such as RFID reader 32. RFID reader 32 may be capable of detecting, or interacting with, one or more RFID tags, for example, RFID tag 34. RFID tag 34 may include a passive or an active RFID tag. Similar to RFID tag 12, RFID tag 34 may be associated with an item 36, such as an article of merchandise, a shipping container, a pallet, an access control device, etc.

RFID reader 32 may detect, or interact with, RFID tag 34 via a wireless communication channel 38. The frequency band and/or wireless communication protocol of wireless communication channel 38 may vary depending upon the nature of RFID tag 34. In one example, wireless communication channel 38 may be a wireless communication channel complying with IEEE specification 802.15.4.

As discussed above with respect to RFID reader 10, in addition to being capable of interacting with, or detecting, RFID tag 34, RFID reader 32 may be capable of communicating with one or more additional devices. As shown, for example, RFID reader 32 may be capable of wirelessly communicating with RFID reader 10 via wireless communication channel 40. Wireless communication channel 40 may be, for example, a communication channel complying with IEEE 802.11a, 802.11b, 802.11g, Wi-Fi, Bluetooth, IEEE 802.15.4, or ZigBee specifications. Wireless communication channel 40 may be the same as, or different than, one or more of wireless communication channels 20, 24, 28.

RFID reader 10 may forward the communication from RFID reader 32 to server computer 14, hub 22, etc. For example, RFID reader 10 may relay the communication from RFID reader 32, e.g., without substantially modifying the contents of the communication. In such an embodiment, RFID reader 10 may effectively extend the range of RFID reader 32. RFID reader 32 may, therefore, communicate, e.g., with server computer 14 at a greater range than may typically be available via wireless communication channel 40. In another embodiment, RFID reader 10 may process or modify the communication from RFID reader 32 and may then forward the communication to another device, e.g., server computer 14.

As discussed above, RFID reader 32 may communicate with RFID reader 10 via wireless communication channel 40. RFID reader 10 may communicate with server computer 14, hub 22, etc. via one or more of wireless communication channels 20 and 24. Wireless communication channels 20, 24, and 40 may be the same as, or different from one or more of the other wireless communication channels. In the foregoing manner, RFID reader 32 may interact with RFID tag 34 via a first wireless protocol, frequency band, etc. RFID reader 32 may also communicate with RFID reader 10 via a second wireless protocol, frequency band, etc., which may be different than, or the same as, the first wireless protocol, frequency band, etc. RFID reader 10 may forward the communication from RFID reader 32 to, or otherwise communicate with, another device, e.g., server computer 14, hub 22, etc, via a third wireless protocol, frequency band, etc., which may be the same as, or different than, one or more of the first and second wireless protocols, frequency bands, etc.

Continuing with the above-stated example, in one implementation the various devices, e.g., RFID readers 10 and 32, additional RFID readers (not shown), hub 22, etc., may form a mesh network. For example, the various devices may each be nodes that may be connected to one or more other node, e.g., via a wireless communication channel or via a wired connection, depending upon the device. The nodes may communicate with one another, either directly or via one or more other nodes. Communication to or from any node may be forwarded to any other node, either directly or indirectly, e.g., via one or more intermediate node. RFID Reader

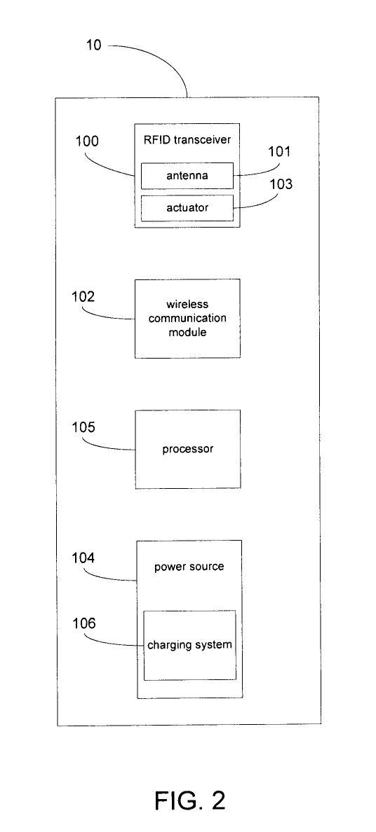

Referring also to FIG. 2, a block diagram of RFID reader 10 is shown. RFID reader 10 may generally include an RFID transceiver 100, a wireless communication module 102 and a power source 104. RFID reader 10 may also include various other components, e.g., a processor 105, a storage device (not shown), a memory (not shown), etc.

RFID transceiver 100 may include the necessary antenna 101, electronics (not shown), etc., for generating and transmitting an interrogation signal, and for receiving a response from RFID tag 12. RFID transceiver 100 may also include an actuator 103 associated with antenna 101. Actuator 103 may be capable of moving antenna 101 between at least a first and a second position. For example, actuator 103 may be capable of adjusting, or altering, the orientation or position of antenna 101. Actuator 103 may include, but is not limited to, a servo, a solenoid, a piezoelectric mover, etc. Actuator 103 may tilt, rotate, shift, etc., antenna 101 to change the field of detection of antenna 101. The magnitude of the movement imparted on antenna 101 may vary depending upon application, from slight (e.g., less than one degree of tilt or an inch of movement) to significant (e.g., tens of degrees of tilt or several inches of movement). In one example, actuator 103 may continuously move antenna 101, e.g., randomly, through a systematic oscillation, etc. In another example, actuator 103 may be configured to intermittently move antenna 101, e.g., at a timed interval, in response to a command, e.g., from server computer 14, etc.

Similarly, wireless communication module 102 may include the necessary electronics, antenna, etc., (not shown) for wirelessly communicating, e.g., with server computer 14, hub 22, etc. Wireless communication module 102 may be configured for communicating via multiple wireless communication channels, e.g., one or more of a communication channel complying with IEEE 802.11a, 802.11b, 802.11g, Wi-Fi, Bluetooth, IEEE 802.15.4, or ZigBee specifications. Additionally/alternatively, RFID reader 10 may include more than one wireless communication module allowing RFID reader 10 to communicate with one or more devices using more than one wireless communication channel.

RFID reader 10 may communicate with server computer 14, directly or through one or more devices, via one or more wireless communication channels using wireless communication module 102. RFID reader 10 may communicate with server computer 14, e.g., to provide server computer 14 with the identification, location, status, etc., of an RFID tag, e.g., RFID tag 12, detected by RFID reader 10. RFID reader 10 may also communicate with server computer 14 regarding the location, status, settings, etc., of RFID reader 10 itself. As noted above, the wireless communication channel may permit bidirectional communication between RFID reader 10 and server computer 14. In addition to providing server computer 14 with information regarding RFID reader 10 or RFID tag 12, RFID reader 10 may receive data, instructions, etc., from server computer 14. For example, RFID reader 10 may receive instructions to change one or more configuration settings, etc. In addition to communicating with server computer 14, RFID reader 10 may also communicate with one or more other devices, such as other RFID readers, hub 22, etc.

Processor 105, along with any associated memory, storage device, etc., may at least in part, control the operation of RFID transceiver 100 and/or wireless communication module. For example, processor 105 may cycle RFID transceiver 100 between an interrogation sequence, in which RFID transceiver 100 may transmit an interrogation signal and receive any transmitted response, and a sleep cycle in which RFID transceiver 100 does not transmit an interrogation signal, and therefore consumes less power. Similarly, processor 105 may, at least in part, control communication, e.g., via wireless communication module 102, with other devices, such as server computer 14. Processor 105 may control various other operations and processes of RFID reader 10.

Power source 104 may provide the necessary power for the operation of RFID reader 10, e.g., RFID transceiver 100, wireless communication module 102, etc. Power source 104 may include, but is not limited to, one or more batteries; AC power, e.g., provided via an AC outlet; DC power, e.g., supplied via a USB connection, DC power supply, etc. Power source 104 may include various typical power management components, circuits, etc. For example, power source 104 may include transformers, rectifiers, etc. to provide a desired voltage, current, etc.

In an embodiment, power source 104 may include one or more disposable batteries, e.g., alkaline batteries. Alternatively, power source 104 may include one or more rechargeable batteries, such as a NiCad battery pack, nickel metal hydride battery pack, lithium ion battery pack, etc. Batteries for RFID reader 10 may be removable/replaceable allowing an at least partially discharged battery to be replaced with a fresh battery. Even in an embodiment in which the battery is a rechargeable battery pack, the battery may be removable/replaceable, e.g., to be recharged separately from RFID reader 10. Of course, batteries may also be recharged while installed in RFID reader 10, e.g., via a direct connection to the charger, or via an indirect connection, e.g., using an inductively-coupled recharger, etc.

RFID reader 10 may also include an on-board charging system 106 that may take advantage of, e.g., environmental conditions, etc. to generate at least a portion of the operating power for RFID reader 10, to charge a rechargeable power source 104, etc. For example, charging system 106 may include a thermo-electric element, photovoltaic element, etc. Various additional/alternative charging elements will also be appreciated.

RFID reader 10 may be used and/or stored in a lighted environment. For example, in an embodiment, RFID reader 10 may be used in connection with a storage or display unit, e.g., in a warehouse, retail space, etc. In such an embodiment, RFID reader 10 may monitor and/or track one or more stored or displayed items by way of RFID tags associated with the one or more items. Storage or display units may include, but are not limited to, for example, racks, bins, shelves, containers, display cases, etc. In such an embodiment, the warehouse, retail space, etc., in which RFID reader 10 is used may be lighted, either by natural lighting or supplemental lighting, e.g., overhead lighting, etc.

Charging system 106 may include a solar cell to take advantage of ambient light for at least a portion of the power needs of RFID reader 10. For example, the solar cell may be coupled to power source 104, e.g., via a trickle charger, etc. The solar cell, which may generate electricity in natural, incandescent, fluorescent, etc. light, may take advantage of most ambient light sources to at least partially recharge power source 104. Additionally/alternatively, the solar cell may provide at least a portion of the power for the operation of RFID reader 10. By at least partially powering RFID reader 10, the solar cell may reduce the draw on power source 104, and may, therefore, prolong the service life of e.g., a battery power source, etc..

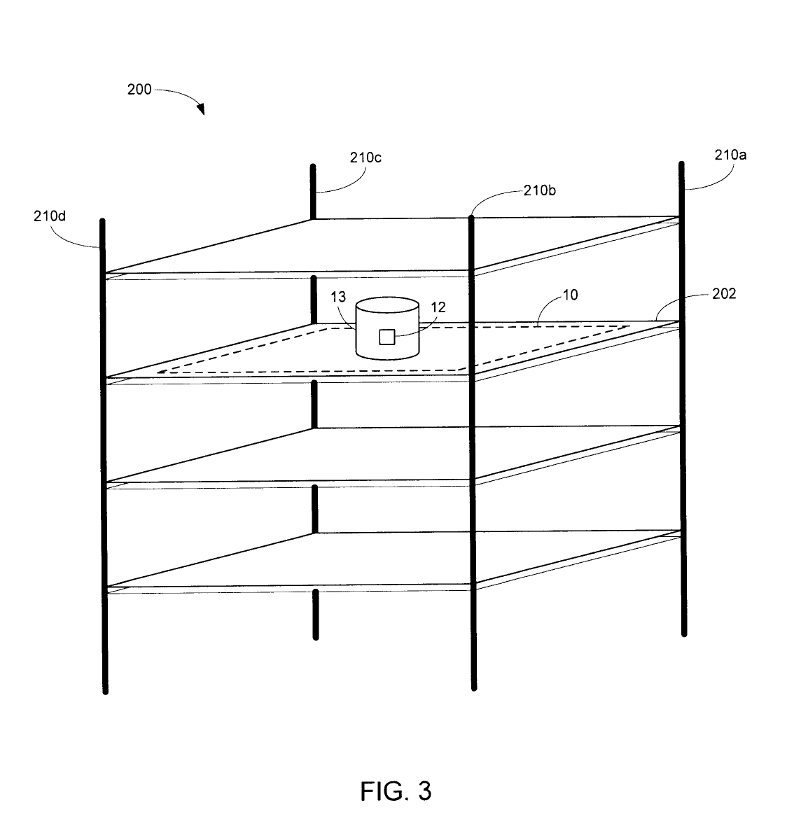

With additional reference to FIG. 3, RFID reader 10 may be used in connection with a shelving system 200. Shelving system 200 may be, for example, storage shelving in a warehouse, a merchandise storage and/or display shelf in a retail store, etc. As shown, the shelving system 200 may include one or more individual shelves, e.g., shelf 202. One or more items, e.g., item 13, may reside on shelf 202 and may include an associated RFID tag, e.g., RFID tag 12. For simplicity of illustration and description, only a single item 13 is shown on shelf 202. RFID tag 12 may be associated with item 13, e.g., RFID tag 12 may be incorporated into package material, attached to or integrated as part of item 13, etc.

RFID reader 10 may be configured to be affixed relative to shelf 202 for detecting and/or monitoring items disposed on the shelf, e.g., item 13, by way of RFID tags, e.g., RFID tag 12, associated with the items on the shelf. RFID reader 10 may use various detection/monitoring schemes depending, for example, on the nature of the items on shelf 202, the frequency that items are added or removed from shelf 202, and the purpose of the detection/monitoring, e.g., inventory control, loss (i.e., theft) prevention, etc.

Inventory control, especially for items with low turnover or in connection with high capacity storage units, may require relatively infrequent monitoring/detection of items in the storage unit. RFID reader 10 may interrogate shelf 202 at regular intervals, e.g., hourly, daily, etc. The intervals at which RFID reader 10 interrogates shelf 202 may be controlled, at least in part, by an internal timer, etc. Additionally/alternatively, RFID reader 10 may be prompted, e.g., by server computer 14 via wireless communication channel 20, to interrogate shelf 202 to determine the presence of item 13, e.g., as indicated by the detection of RFID tag 12. RFID reader 10 may enter a low power consumption state, e.g., a sleep state, in between interrogation sequences. Entering the sleep state in between interrogation sequences may increase the service life of power source 104, which may consequently require less frequent charging or replacement.

The prevention of theft, and the recovery of stolen items may depend, at least in part, on quickly detecting the removal of the stolen item from the storage or display unit. When used for loss prevention, RFID reader 10 may frequently and/or continuously interrogate shelf 202 for the presence of item 13, e.g., as indicated by the detection of RFID tag 12, associated with item 13.

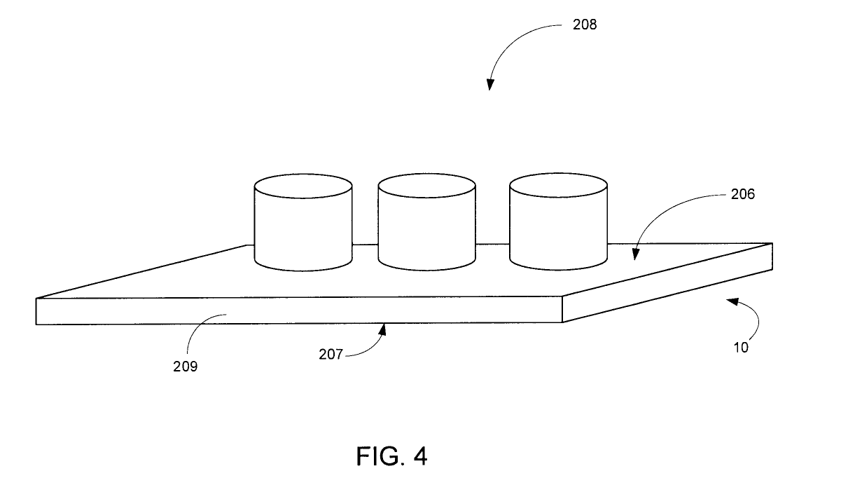

Continuing with the above-stated example, in which RFID reader 10 may be used in connection with shelving unit 200, and with reference also to FIG. 4, RFID reader 10 may be configured having a generally flat configuration, e.g., having a generally planar housing 209. RFID reader 10 may further present a generally flat and/or load bearing surface 206, which may be configured to support one or more items 208, collectively. Generally planar RFID reader 10 may be located on shelf 202, and one or more items may be placed on the load bearing surface 206. As such, RFID reader 10 may be within range to monitor/detect any RFID tags associated with one or more of the items placed on the shelf. RFID reader 10 may have, for example, a generally flat mounting surface 207 to facilitate affixing RFID reader 10 to shelf 202. Various other mounting surface configurations may be used to facilitate affixing the RFID reader relative to various other structures.

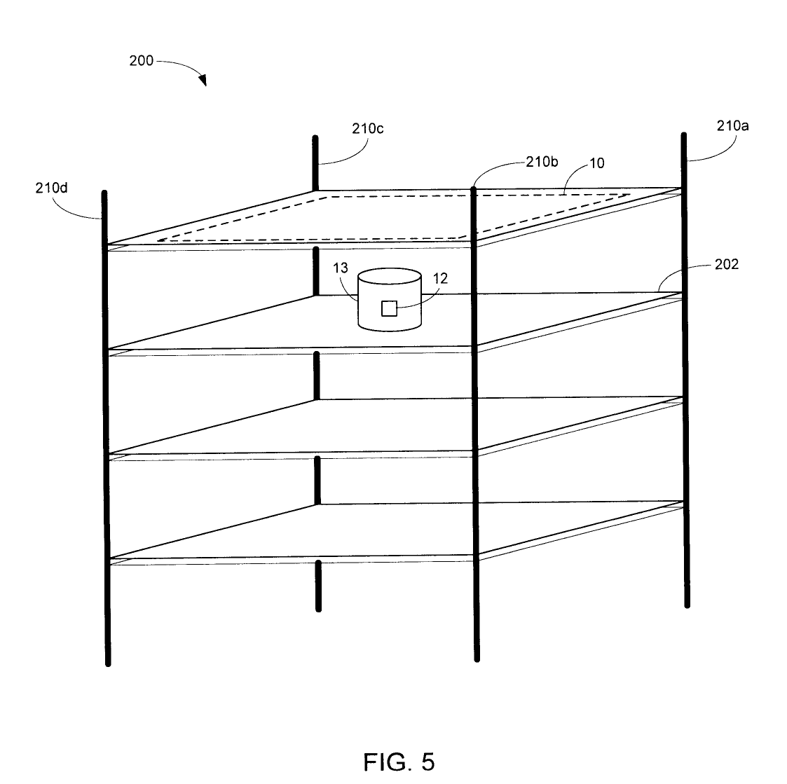

Referring also to FIG. 5, in a related embodiment, rather than placing RFID reader 10 on shelf 202, and placing item 13 directly on a load bearing surface of RFID reader 10, RFID reader 10 may be placed above shelf 202 and item 13 thereon. RFID reader 10 may be positioned to monitor/detect RFID tag 12 associated with item 13 on shelf 202 below RFID reader 10. In a related embodiment (not shown), the RFID reader may be attached to the bottom surface of the shelf. The RFID reader may transmit an interrogation signal through the shelf to monitor/detect any RFID tags associated with items disposed on the shelf.

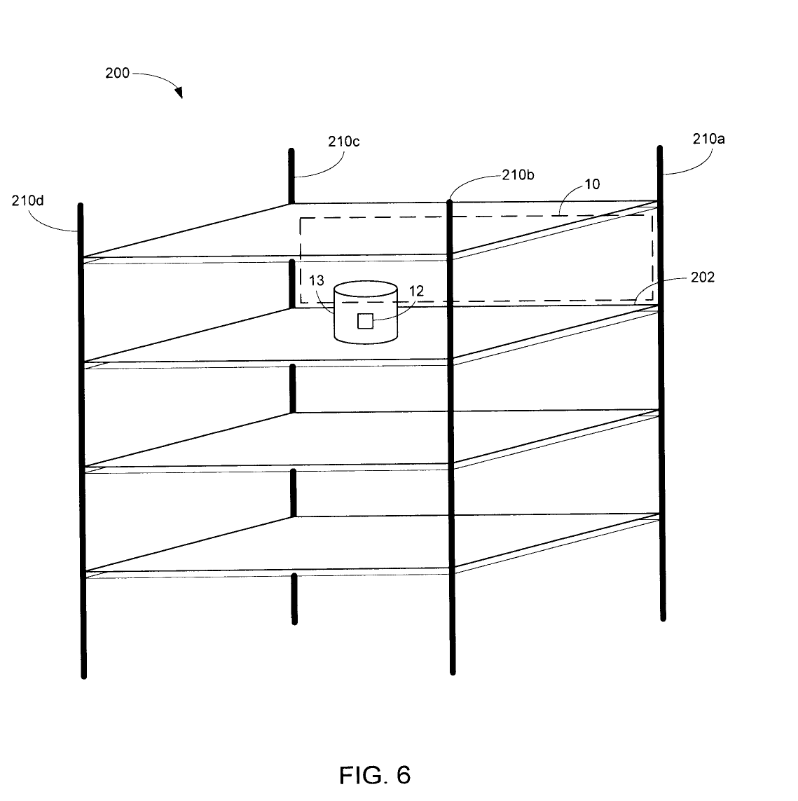

With additional reference to FIG. 6, RFID reader 10 may also be oriented generally perpendicular to shelf 202, e.g., in a generally vertical orientation. Generally vertically oriented RFID reader 10 may be located, e.g., adjacent to the rear of shelving unit 200. RFID reader 10 may be configured to detect RFID tag 12 associated with item 13 on the shelf in front of RFID reader 10. Consistent with the foregoing configurations, a single RFID reader may be associated with each shelf including items to be monitored/detected.

As a further extension of the previously described embodiments, an RFID reader may be affixed below a shelf, e.g., to the underside of the shelf, and may monitor/detect any RFID tags associated with items on the shelf above the RFID reader. The RFID reader may also monitor/detect any RFID tags associated with items on the shelf below the RFID reader. In such an embodiment, a single RFID reader may monitor/detect any RFID tags associated with items on the shelf above the RFID reader, as well as with items on the shelf below the RFID reader. Of course, such implementations may vary based on the effective detection range of RFID reader 10 or tag 12, on shelf spacing, shelf material, etc.

RFID reader 10 may be configured to be affixed relative to shelving unit 200 in a number of ways. For example, RFID reader 10 may simply be placed on shelf 202 and may be supported by shelf 202. RFID reader 10 may also be attached relative to an upper, or lower surface of shelf 202, e.g., via magnetic fasteners, mechanical fasteners, adhesives, etc. Additionally, RFID reader 10 may be attached to a support structure of shelving unit 200, e.g., to vertical supports 210a-d. In a particular embodiment, RFID reader 10 may be integrated into shelf 202, e.g., a housing of the RFID reader may be the shelf.

Additionally, especially when it is used in connection with product or merchandise display systems, the RFID reader may be colored or include graphics, etc., that may compliment, indicate, correspond to, etc., products associated with the display. For example, an RFID reader used in connection with a display for DeWalt® brand cordless power tools may have a yellow and black color scheme, may include the DeWalt® logo, etc. In such embodiments, the RFID reader itself may be an integrated component of the display or advertising campaign associated with the merchandise, retailer, etc. Of course, numerous variations on the above concept are possible. For example, the RFID reader may be formed from a clear material, allowing replaceable color schemes and graphics to be added by placing printed displays relative to the inside surface, etc.

Implementation of RFID reader 10 in connection with a storage unit, display unit, etc., may be facilitated by eliminating, or at least reducing, the need for external connections. For example, power source 104 may eliminate the need of providing wired electrical service to individual RFID readers associated with shelving unit 200, e.g., RFID reader 10. Eliminating the need for wired electrical service may facilitate the use of RFID reader 10 in connection with moveable/reconfigurable storage or display units. That is, such storage or display units may be moved and/or reconfigured without also requiring similar movement and/or reconfiguration of associated wired electrical service. Similarly, often storage and display units may be located away from any walls, partitions, etc. which may readily house and conceal electrical wiring. A battery powered RFID reader may eliminate the need for expensive, labor intensive, and undesired ceiling drop wiring, through floor wiring, etc.

Even in connection with permanent storage or display units, and/or storage or display units in locations that are readily susceptible to the use of wired electrical service, running the electrical service and connecting individual RFID readers may involve a substantial amount of labor and material, which may add to the expense and inconvenience associated with installing such RFID readers. Similarly, the need for hardwired physical communication pathways may also be avoided by making use of wireless communication channels for communicating information relating the monitored/detected RFID tags, and/or to the RFID reader itself, etc. Similar to the savings associated with avoiding the need for wired electrical service, the use of wireless communication channels may reduce the cost and labor associated with the installation and use of an RFID reader consistent with the present disclosure.

In various embodiments the thickness of an RFID reader, e.g., used in connection with a storage or display system, may be relatively small, e.g., less than one inch to several inches in thickness. The thickness of the RFID reader may be reduced, for example, by forming one surface of a housing from metal, which may be used as a ground plane for a patch antenna, which may be employed by the RFID reader, thereby avoiding the need for separate ground plane and housing layers. Similarly, the components of the RFID reader, e.g., the RFID transceiver, the wireless communication module, the processor, etc. may be formed on a common substrate, e.g., a single printed circuit board. As such, the thickness associated with connectors joining several individual boards may be reduces and/or eliminated.

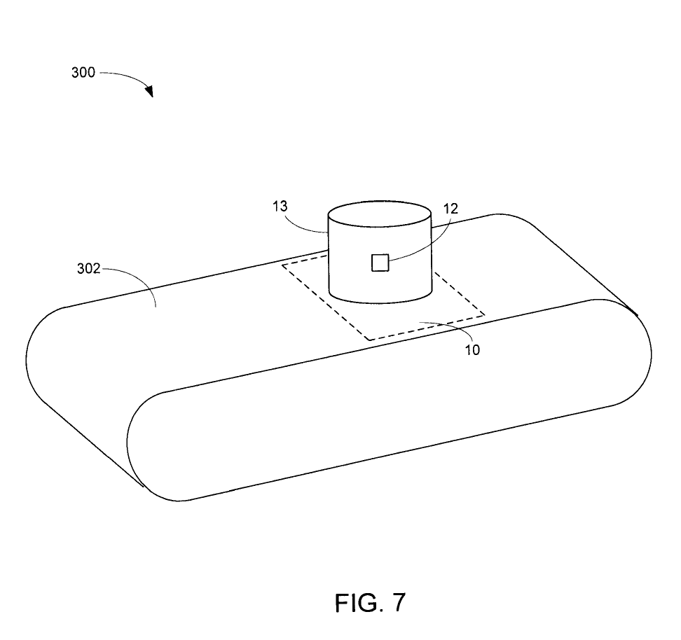

Turning to FIG. 7, RFID reader 10 may be implemented in connection with a conveyor system 300. Conveyor system 300 may include, for example, a conveyor belt 302, which may be used for transporting items, e.g., item 13, in connection with manufacturing, shipping, delivery, etc. of item 13. RFID reader 10 may be affixed relative to conveyor system 300 for monitoring/detecting RFID tag 12, which may be associated with item 13. As item 13 passes along conveyor belt 302, RFID reader 10 may interrogate item 13 to monitor and/or detect RFID tag 12. RFID reader 10 may wireless communicate the detection of RFID tag 12 to one or more other devices in the RFID system, e.g., sever computer 14, allowing items transported on conveyor system 300 to be tracked, logged, etc.

Similar to the implementation of RFID reader 10 in connection with a storage unit, display unit, etc., the use of RFID reader 10 in connection with conveyer system 300 may be facilitated by the use of battery power and wireless communication with other devices in the RFID system. For example, RFID reader 10 may be implemented in connection with conveyor system 300 by simply affixing RFID reader 10 in a desired location suitable for interrogating RFID tags associated with items transported on conveyor belt 302. RFID reader 10 may be used in connection with conveyor system 300 without the need to provide separate, or additional, electrical service or hardwired communication links. As such, the overhead associated with implementing RFID reader 10 in connection with conveyor system 300 may be relatively low.

A number of implementations of the present invention have been provided by way of illustrations. Numerous variations and modifications may be made to the disclosed implementations. Accordingly, other implementations are within the scope of the following claims.

What is claimed is:

1. A system comprising:
An RFID reader configured to detect an RFID tag, the RFID reader comprising a mounting surface configured to be affixed relative to an external structure, the RFID reader capable of being wirelessly coupled to a receiver for transmitting data to the receiver.

2. The system of claim 1, wherein the mounting surface is configured to be affixed relative to a shelving system.

3. The system of claim 2, wherein the RFID reader comprises a substantially flat load bearing surface.

4. The system of claim 1, wherein the mounting surface is configured to be fixed relative to a conveyor system.

5. The system of claim 1, wherein the RFID reader is powered by a battery.

6. The system of claim 1, wherein the battery comprises a rechargeable battery.

7. The system of claim 6, further comprising a solar cell capable of at least partially recharging the rechargeable battery.

8. The system of claim 1, wherein the RFID reader is configured to be wirelessly coupled to a second RFID reader.

9. The system of claim 1, wherein the RFID reader is configured to be wirelessly coupled to a server computer.

10. An RFID reader comprising:
a housing configured to be affixed relative to an external structure;
a communication module capable of wirelessly communicating data to a receiver; and
an RFID transceiver capable of detecting an RFID tag.

11. The RFID reader of claim 10, wherein the housing is configured to be affixed to a shelving structure.

12. The RFID reader of claim 11, wherein the housing comprises a substantially flat structure configured to be affixed relative to a shelf.

13. The RFID reader of claim 10, further comprising a battery power source.

14. The RFID reader of claim 13, further comprising a solar cell configured for at least one of at least partially powering at least one of the RFID transceiver and the communication module, or at least partially recharging the battery power source.

15. The RFID reader of claim 10, wherein the communication module is capable of wirelessly transmitting data to a second RFID reader.

16. The RFID reader of claim 10, wherein the communication module is capable of wirelessly transmitting data to a server computer.

17. The RFID reader of claim 10, wherein the RFID transceiver comprises an antenna and an actuator capable of moving the antenna between at least a first and a second position.

18. The RFID reader of claim 10, wherein the housing has an appearance at least partially matching a known brand.

19. The RFID reader of claim 10, wherein the communication module and the RFID transceiver are formed on a common substrate.

20. A shelving system comprising:
a least one shelf;
an RFID reader associated with the at least one shelf, the RFID reader comprising an RFID transceiver configured to detect an RFID tag, and a communication module capable of wirelessly communicating with a receiver.

21. The shelving system of claim 20, wherein the RFID reader comprises a substantially flat load bearing surface.

22. The shelving system of claim 20, wherein the RFID reader is configured to be affixed relative to a top of the shelf.

23. The shelving system of claim 20, wherein the RFID reader is configured to be wirelessly coupled to a second RFID reader.

24. The shelving system of claim 20, wherein the RFID reader is configured to be wirelessly coupled to a server computer.

25. The shelving system of claim 20, where the RFID reader further comprises a battery power source.
